(19) United States
(12) Patent Application Publication
(10) Pub. No.: US 2019/0317821 A1
(43) Pub. Date: Oct. 17, 2019

(54) DEMAND-BASED UTILIZATION OF CLOUD COMPUTING RESOURCES

(71) Applicant: Kazuhm, Inc., San Diego, CA (US)

(72) Inventors: Tim O'NEAL, Carlsbad, CA (US); Andreas ROELL, San Diego, CA (US)

(21) Appl. No.: 16/385,625

(22) Filed: Apr. 16, 2019

Related U.S. Application Data
(60) Provisional application No. 62/658,524, filed on Apr. 16, 2018.

(51) Int. Cl. G06F 9/50; G06F 9/455

(52) U.S. Cl. CPC G06F 9/5044; G06F 9/5077; G06F 2009/45595; G06F 9/505; G06F 2009/4557; G06F 9/45558

(57) ABSTRACT

Certain aspects of the present disclosure provide a method for managing distributed computing resources, including: receiving a processing job request; determining that available system resources are insufficient to process the job; installing a container in a cloud processing node; installing an application in the container in the cloud processing node; splitting a processing job into a plurality of chunks; and distributing at least one of the plurality of chunks to an on-site processing node and at least another one of the plurality of chunks to a cloud processing node.

### CROSS-REFERENCE TO RELATED APPLICATIONS

This Application claims the benefit of U.S. Provisional Patent Application No. 62/658,524, filed on Apr. 16, 2018, which is incorporated herein by reference in its entirety.

### INTRODUCTION

Aspects of the present disclosure relate to systems and methods for managing distributed computing resources.

Computing is increasingly ubiquitous in modern life. Whether it is a smartphone, smart appliance, self-driving car, or some other application, the amount of active computing devices, and therefore available computing resources, is beyond measure. The demand for computing resources is likewise increasing at a substantial rate. Organizations of all types are finding reasons to analyze more and more data to their respective ends.

Many complimentary technologies have changed the way computing is handled for various users and organizations. For example, improvements in networking performance and availability (e.g., via the Internet) have enabled organizations to rely on cloud-based computing resources rather than building out dedicated, high-performance computing infrastructure to perform data analysis, host enterprise applications, and the like. In particular, organizations have widely embraced cloud computing to accommodate increasing demands for processing data without the need to add more and more physical computing resources on-site. The promise of cloud-based computing resource providers is that it such resources are cheaper, more reliable, easily scalable, and potentially best of all—such resources do not require any high-performance on-site computing equipment. Features aside, for many organizations, the decision between purchasing on-site computing resources and paying for “virtual” cloud-based resources boils down to cost. Unfortunately, the myriad promises relating to cloud-based computing have not all come to fruition. In particular, the cost of cloud-based computing resources has turned out in many cases to be as expensive as or more expensive than building dedicated on-site hardware. Moreover, cloud-based customers are subject to the whims of the cloud-based resource providers in terms of cost, availability, features, etc.

While organizations may not want to rely on cloud-based computing resources for their primary processing needs, they may nevertheless wish to have the ability to tap into such resources on a demand-basis. For example, if a temporary need for computing resources exceeds an organization's on-site capabilities, or if a problem arises with on-site equipment, an organization may wish to leverage cloud-based processing resources to cover either situation. Unfortunately, most distributed computing systems are designed for one configuration or another (i.e., on-site only, or off-site only), not for both.

Accordingly, what are needed are systems and methods for enabling cloud-based processing on a demand basis in a distributed computing resource management system.

### BRIEF SUMMARY

Certain embodiments provide a method for managing distributed computing resources, including: receiving a processing job request; determining that available system resources are insufficient to process the job; installing a container in a cloud processing node; installing an application in the container in the cloud processing node; splitting a processing job into a plurality of chunks; and distributing at least one of the plurality of chunks to an on-site processing node and at least another one of the plurality of chunks to a cloud processing node.

Other embodiments provide a non-transitory computer-readable medium comprising instructions to perform the method for managing distributed computing resources. Further embodiments provide an apparatus configured to perform the method for managing distributed computing resources.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an embodiment of a heterogeneous distributed computing resource management system.

FIG. 2 depicts an example of a container of a heterogeneous distributed computing resource management system.

FIG. 3 depicts an example method for demand-based utilization of cloud computing resources.

FIG. 4 depicts an example processing system.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for managing distributed computing resources.

A distributed computing resource system may include access to a variety of computing resources controlled by an organization. For example, such computing resources may include on-site resources located at one or more facilities owned and/or operated by the organization. In most cases, such a distributed computing resource system may meet the organization's processing needs. However, in some cases, the distributed computing resource system may not meet the needs, whether through fault, lack of peak capacity, or otherwise. For such an organization, the choice has conventionally been to increase the capacity of on-site resources to meet the peak potential need, even if such potential is rarely if ever needed. Consequently, organizations are forced to purchase and maintain systems that are over-built and thus more costly than necessary for the vast majority of their processing needs.

Cloud-based computing platforms, such as AMAZON WEB SERVICES, MICROSOFT AZURE, GOOGLE CLOUD SERVICES, IBM CLOUD, and the like have offered organizations an alternative to building and maintaining on-site processing systems. While convenient, the cost of such services can be prohibitive for the same reason as on-site equipment installations—because in the cloud context an organization needs to pay for a service that offers enough capacity for a peak need that may rarely be the actual need.

A solution to the conventional choice between on-site equipment installations and cloud-based services is to leverage the strength of both by allowing an on-site system to leverage cloud-based processing power on-demand. Such a capability may be referred to as cloud-burst processing capacity i.e., where a burst of processing need is handled by a cloud-based processing service in addition to an on-site processing system. In this way, an organization may be able to purchase access to the cloud-based service on an as-needed or on-demand basis. Even if such a la carte processing plans are not available at a particular cloud-based processing service, an organization can still subscribe to such service with a much less expensive plan since the cloud-based service need only handle overflow processing and not the bulk of the processing.

### Example Distributed Computing Resource Management System Including Demand-Based Cloud Processing Capability

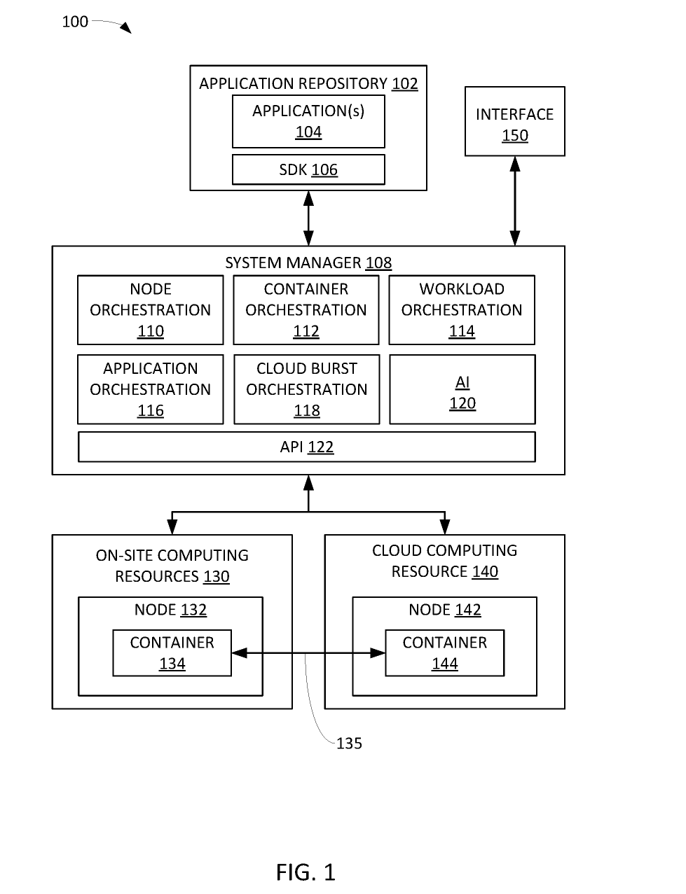

FIG. 1 depicts an embodiment of a heterogeneous distributed computing resource management system 100.

Management system 100 includes an application repository 102. Application repository 102 stores and makes accessible applications 104. Applications 104 may be used by management system 100 in containers deployed on resources managed by system 100, such as containers 134 and 144. In some examples, application repository 102 may act as an application marketplace for developers to market their applications.

Application repository includes a software development kit 106, which may include a set of software development tools that allows the creation of applications (such as applications 104) for a certain software package, software framework, hardware platform, computer system, video game console, operating system, or similar development platform. Some SDKs are critical for developing a platform-specific application. For example, the development of an Android app on Java platform requires a Java Development Kit, for iOS apps the iOS SDK, and for Universal Windows Platform the .NET Framework SDK, and others. There are also SDKs that are installed in apps to provide analytics and data about activity. In some cases, and SDK may implement one or more application programming interfaces (APIs) in the form of on-device libraries to interface to a particular programming language, or to include sophisticated hardware that can communicate with a particular embedded system. Common tools include debugging facilities and other utilities, often presented in an integrated development environment (IDE). Note, though shown as a single SDK 106 in FIG. 1, SDK 106 may include multiple SDKs.

Management system 100 also includes system manager 108. System manager 108 may alternatively be referred to as the “system management core” or just the “core” of management system 100. System manager 108 includes many modules, including a node orchestration module 110, container orchestration module 112, workload orchestration module 114, application orchestration module 116, cloud orchestration module 118, and artificial intelligence (AI) module 120. Notably, in other embodiments, system manager 108 may include only a subset of the aforementioned modules, while in yet other embodiments, system manager 108 may include additional modules.

System manager 108 may be configured to manage the overall functions of container orchestration module 112, workload orchestration module 114, application orchestration module 116, cloud burst orchestration module 118 and AI module 120. For example, system manager 108 may provide the control interface between interface 150 and all the aforementioned modules.

Node orchestration module 110 is configured to manage all nodes associated with management system 100. For example, node orchestration module 110 may register new nodes with the system. Node orchestration module 110 may also monitor whether a particular node is online as well as status information associated with each node, such as what the processing capacity of the node is, what the network capacity of the node is, what type of network connection the node has, what the memory capacity of the node is, what the storage capacity of the node is, what the battery power of the node is (if it is a mobile node not running on batter power), etc. Node orchestration module 110 may share status information with AI module 120. Node orchestration module 110 may receive messages from nodes as they come online in order to make them available to management system 100 and may also receive status messages from active nodes in the system.

Node orchestration module 110 may also control the configuration of certain nodes according to predefined node profiles. For example, node orchestration module 110 may assign a node (e.g., 132) as a processing node, a storage node, a security node, a monitoring node, or other types of nodes.

A processing node may generally be tasked with data processing by management system 100. As such, processing nodes may tend to have high processing capacity and availability. Processing nodes may also tend to have more applications installed in their respective containers compared to other types of nodes.

A storage node may generally be tasked with data storage. As such, storage nodes may tend to have high storage availability.

A security node may be tasked with security related tasks, such as monitoring activity of other nodes, including nodes in common sub-pool of resources, and reporting that activity back to security module 122. A security node may also have certain, security related types of applications, such as virus scanners, intrusion detection software, etc.

A monitoring node may be tasked with monitoring related tasks, such as monitoring activity of other nodes, including nodes in a common sub-pool of resources, and reporting that activity back to monitoring module 124. Such activity may include the nodes availability, the nodes connection quality, and other such data.

Not all nodes need to be a specific type of node. For example, there may be general purpose nodes that include capabilities associated with one or more of processing, storage, security, and monitoring.

Container orchestration module 112 manages the deployment of container to various nodes, such as containers 134 and 144 to nodes 132 and 142, respectively. Thus, container orchestration module 112 may control the installation of containers on cloud computing resources, such as cloud computing resource 140. In some cases, container orchestration module 112 may interact with node orchestration module 110 to determine the status of various containers on various nodes associated with system 100.

Workload orchestration module 114 is configured to manage workloads distributed to various nodes, such as nodes 132 and 142. For example, when a job is received by management system 100, for example by way of interface 150, workload orchestration module 114 may distribute the job to one or more nodes for processing. In particular, workload orchestration module 114 may receive node status information from node orchestration module 110 and distribute the job to one or more nodes in such a way as to optimize processing time and maximize resources utilization based on the status of the nodes connected to the system.

In some cases, when a node becomes unavailable (e.g., goes offline) or become insufficiently available (e.g., does not have adequate processing capacity), workload orchestration module 114 will reassign the job to one or more other nodes. For example, if workload orchestration module 114 had initially assigned a job to node 132, but then node 132 went offline, then workload orchestration module may reassign the job to another on-site node. In some cases, the reassignment of a job may include the entire job, or just a portion of a job that was not yet completed by the original assigned node. Workload orchestration module 114 also provides splitting (or chunking) operations. Splitting or chunking is the act of breaking a large processing job down in to small parts that can be processed by multiple processing nodes at once (i.e., in parallel). Notably, workload orchestration may be handled by system manager 108 as well as by one or more nodes. For example, an instance of workload orchestration module 114 may be loaded onto a node to manage workload within a sub-pool of resources in a peer-to-peer fashion in case access to system manager 108 is not always available.

Workload orchestration module 114 may also include scheduling capabilities. For example, schedules may be configured to manage computing resources (e.g., node 132) according to custom schedules to prevent resource over-utilization. In one example, a node may configured such that it can be used by system 100 only during certain hours of the day. In some cases, multiple levels of resource management may be configured. For example, a first percentage of processing resources at a given node may be allowed during a first time interval (e.g., during working hours) and a second percentage of processing resources may be allowed during a second time interval (e.g., during non-working hours). In this way, the nodes can be configured for maximum resource utilization without negatively affecting end-user experience with the nodes during regular operation (i.e., operation unrelated to system 100). In some cases, schedules may be set through interface 150.

As above, in this example, workload orchestration module 114 is a part of system manager 108, but in some examples an orchestration module may be resident on a particular node, such as node 132, to manage the nodes resources as well as other node's resources in a peer-to-peer management scheme. This may allow, for example, jobs to be managed by a node locally while the node moves in and out of connectivity with system manager 108.

Application orchestration module 116 is configured to manage which applications are installed in which containers, such as containers 134 and 144. For example, workflow orchestration module 114 may assign a job to a node that does not currently have the appropriate application installed to perform the job. In such a case, application orchestration module 116 may cause the application to be installed in the container from, for example, application repository 102.

In some examples, application orchestration module 116 may manage the initial installation of applications (e.g., applications 104) in containers on new nodes. For example, if a container was installed in node 134, application orchestration module 116 may direct an initial set of applications to be installed on node 134. In some cases, the initial set of applications to be installed on a node may be based on a profile associated with the node. In other cases, the initial set of applications may be based on status information associated with the node (such as collected by node orchestration module 110). For example, if a particular node does not regularly have significant unused processing capacity, application orchestration module 116 may determine not to install certain applications that require significant processing capacity.

Application orchestration module 116 is also configured to manage applications once they are installed in containers, such as in containers 134 and 144. For example, application orchestration module 116 may enable or disable applications installed in containers, grant user permissions related to the applications, and grant access to resources. Application orchestration module 116 enables a software developer to, for example, upload new applications, remove applications, manage subscriptions associated with applications, receive data regarding applications (e.g., number of downloads, installs, active users, etc.) in application repository 102, among other things.

Like workload orchestration module 114, in some cases application orchestration module 116 may be installed on a particular node to manage deployment of applications in a cluster of nodes. As above, this may reduce reliance on system manager 108 in situations such as intermittent connectivity.

Cloud burst orchestration module 118 is configured to control when a processing job is sent to a cloud computing resource, such as cloud computing resource 140. For example, cloud burst orchestration module 118 may determine when the on-site computing resources 130 are insufficient to meet the current processing demand. In some cases, cloud burst orchestration module 118 may determine to use cloud computing resource 140 when a certain threshold is crossed. The threshold may be based on processing resources available, storage resources available, or any other resource. In some examples, cloud burst orchestration module 118 may interact with workload orchestration module 114 to determine the capacity of the on-site computing resources.

AI module 120 may be configured to interact with various parts of system manage 108 in order to optimize the performance of management system 100. For example, AI module 120 may monitor performance characteristics associated with various nodes and feedback workload optimizations to workload orchestration module 114 Likewise, AI module 120 may predict resource issues and interact with cloud burst orchestration module 118 to offload processing or other computing resource needs to cloud computing resource 140.

AI module 120 may include a variety of machine-learning models in order to analyze data associated with management system 100 and to optimize its performance.

Application programming interface (API) 122 may be configured to allow any of the aforementioned modules to interact with nodes (e.g., 132 and 142) or containers (e.g., 134 and 144). Further, API 122 may be configured to connect third-party applications and capabilities to management system 100. For example, API 122 may provide a connection to third-party storage systems, such as AMAZON S3, EGNYTE, and DROPBOX, among others. API 122 may also be configured to connect to third-party processing services, such as AMAZON WEB SERVICES, MICROSOFT AZURE, GOOGLE CLOUD SERVICES, IBM CLOUD, and others.

Node 132 may be any sort of computing resource that is capable of having a container installed on it. For example, nodes 132 may be a desktop computer, laptop computer, tablet computer, server, gaming console, or any other sort of computing device.

Interface 150 provides a user interface for users to interact with system manager 108.

In some cases, an on-site computing resource, such as node 132, may interact directly with a cloud computing resource, such as node 142 (as indicated by arrow 135). For example, node 132 may include a local instance of a workload orchestration module, which may direct processing jobs to an application in container 144 of node 142 in cloud computing resource 140. In this way, parallel processing of jobs may not only be handled in parallel by on-site computing resources 130 and cloud computing resource 140, but may also be dynamically managed by the bidirectional data flow between the various nodes.

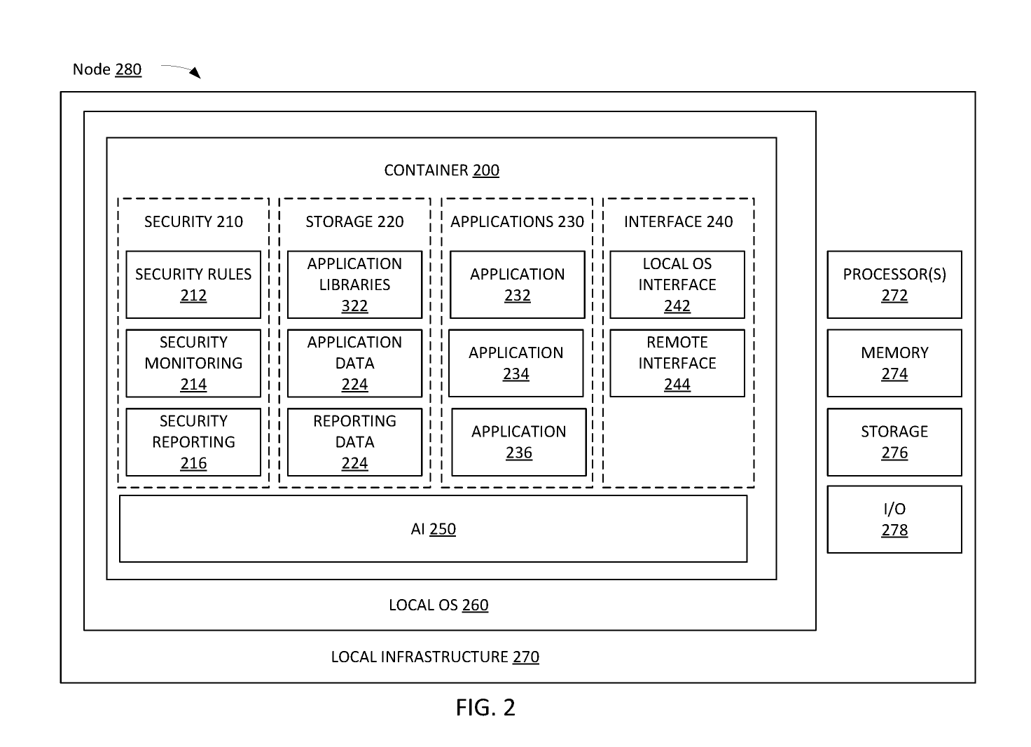

FIG. 2 depicts an example of a container 200 as may be used in a heterogeneous distributed computing resource management system, such as system 100 in FIG. 1.

As depicted, container 200 is resident within and interacts with a local operating system (OS) 260. In this example, container 200 includes a local OS interface 242, which may be configured based on the type of local OS 260 (e.g., a WINDOWS interface, a MAC OS interface, a LINUX interface, or any other type of operating system). By interfacing with local OS 260, container 200 need not have its own operating system (like a virtual machine) and therefore container 200 may be significantly smaller in size as compared to a virtual machine. The ability for container 200 to be significantly smaller in installed footprint means that container 200 works more readily with a wide variety of computing resources, including those with relatively small storage spaces (e.g., certain types of mobile devices).

Container 200 includes several layers, including (in this example) security layer 210, storage layer 220, application layer 230, and interface layer 240.

Security layer 210 includes security rules 212, which may define local security policies for container 200. For example, security rules 212 may define the types of jobs container 200 is allowed to perform, the types of data container 200 is allowed to interact with, etc. In some cases, security rules 212 may be defined by and received from system manager 108 (of FIG. 1). In some cases, the security rules 212 may be defined by an organization's SIEM software as part of container 200 being installed on node 280.

Security layer 210 also includes security monitoring module 214, which may be configured to monitor activity related to container 200 as well as node 280. In some cases, security monitoring module 214 may be configured by, or under control of, system manager 108 of FIG. 1. Having a local security layer 210 may be particularly useful where certain computing resources, such as node 280, are not connected to outside networks for security reasons, such as in the case of secure compartmentalized information facilities (SCIFs).

Security layer 210 also includes security reporting module 216, which may be configured to provide regular, periodic reports of the security state of container 200, as well as event-based specific reports of security issues. For example, security reporting module 216 may report back to system manager 108 (in FIG. 1) any condition of container 200, local OS 260, or node 280, which suggests a potential security issue, such as a breach of one of security rules 212.

In some cases, security layer 210 may interact with AI 250. For example, AI 250 may monitor activity patterns and flag potential security issues that would not otherwise be recognized by security rule 212. In this way, security layer 210 may be dynamic rather than static.

Container 200 also includes storage layer 220, which is configured to store data related to container 200. For example, storage layer 220 may include application libraries 222 related to applications installed within container 200 (e.g., applications 230). Storage layer 220 may also include application data 224, which may be produced by operation of applications 230. Storage layer 220 may also include reporting data 224, which may include data regarding the performance and activity of container 200.

Storage layer 220 is flexible in that the amount of storage needed by container 200 may vary based on current job loads and configurations. In this way, container 200's overall size need not be fixed and therefore need not waste space on node 280.

Notably, the components of storage layer 220 depicted in FIG. 2 are just one example, and many other types of data may be stored within storage layer 220.

Container 200 also includes application layer 230, which comprises applications 232, 234, and 236 loaded within container 200. Applications 232, 234, and 236 may perform a wide variety of processing tasks as assigned by, for example, workload orchestration module 114 of FIG. 1. In some cases, applications within application layer 230 may be configured and managed by application orchestration module 116.

The number and type of applications loaded into container 200 may be based on one or more roles defined for node 280. For example, one role may call for application 232 to be installed, and another role may call for applications 234 and 236 to be installed. Because the roles assigned to a particular node (such as node 280) are dynamic, the number and type of applications installed within container 200 may likewise be dynamic.

Container 200 also includes interface layer 240, which is configured to give container 200 access to local resources of node 280 as well as to interface with a management system, such as management system 100 described above with respect to FIG. 1.

Local OS interface module 242 enables container 200 to interact with local OS 260, which gives container 200 access to local infrastructure 270, including the local computing resources, of node 280. In other words, container 200 is able to leverage the processor or processors 272, memory 274, storage 276, and I/O 278 of node 280. Processors 272 may include general purpose processors (e.g., CPUs) as well as special purpose processors (e.g., GPUs). I/O 278 may include, for example, networking interfaces, display outputs, etc.

Remote interface module 244 provides an interface with a management system, such as management system 100 described above with respect to FIG. 1. For example, container 200 may interact with container orchestration module 112, workload orchestration module 114, application orchestration module 116, cloud burst orchestration module 118, and others of management system 100 by way of remote interface 244.

Container 200 includes a local AI 250. In some examples, AI 250 may be a local instance of AI module 120 described with respect to FIG. 1, while in others AI 250 may be an independent, container-specific AI. In some cases, AI 250 may exist as separate instances within each layer of container 200. For example, there may be an individual AI instance for security layer 210 (e.g., to help identify non-rule based security issues), storage layer 220 (e.g., to help analyze application data), application layer 230 (e.g., to help perform specific job tasks), and/or interface layer 240 (e.g., to interact with a system-wide AI).

### Example Method for Demand-Based Utilization of Cloud Computing Resources

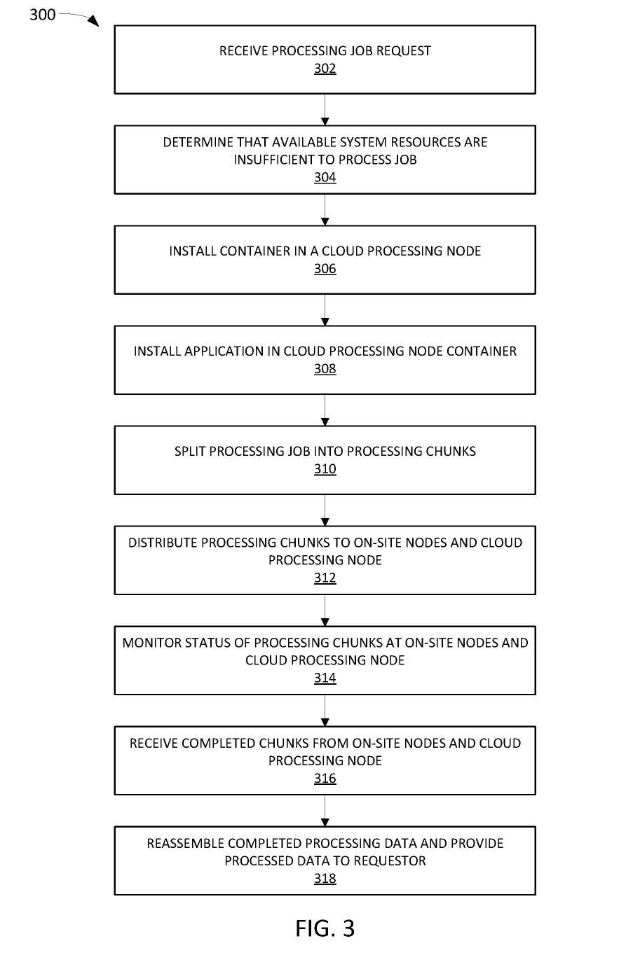

FIG. 3 depicts an example method 300 for demand-based utilization of cloud computing resources that may be performed by a heterogeneous distributed computing resource management system, such as system 100 in FIG. 1.

Method 300 begins at step 302 where a processing job request is received. For example, a request may be received from a user of the system via interface 150 of FIG. 1. The job request may be for any sort of processing that may be performed by a distributed computing system. For example, the request may be to transcode a video file from one format to another format.

In some examples, the job request may include parameters associated with the processing job, such as the maximum amount of time acceptable to complete the processing job. Such parameters may be considered by, for example, workload orchestration node 114 of FIG. 1 to determine the appropriate computing resources to allocate to the requested processing job.

Method 300 then proceeds to step 304 where a determination is made that the available system resources (e.g., of on-site computing resources 130 in FIG. 1) are insufficient to process the requested job.

In some cases, the determination of insufficiency may be based on one or more factors of sufficiency. For example, one factor may be whether or not the available system resources are capable of performing the job at all. Another factor may be whether or not the available system resources are capable of performing the job within a certain timeframe, for example within a time frame received as a parameter of the job request. Another factor may be whether the job can be completed while maintaining a level of available resources in the system for other jobs (e.g., with respect to total system capacity). Other factors are possible.

In some cases, determining that available system resources are insufficient to process the job comprises determining a total resource utilization of the system is above a predetermined threshold.

Method 300 then proceeds to step 306, where a containers, such as container 200 described with respect to FIG. 2, is installed in a cloud processing node (e.g., node 142 in FIG. 1). In some examples, container orchestration module 112 of FIG. 1 may perform the installation of the containers in the cloud processing node.

The method 300 then proceeds to step 308 where applications are installed in the container in the cloud processing node. For example, applications may be installed and managed by application orchestration module 116, as described above with respect to FIG. 1.

The method 300 then proceeds to step 310 where the processing job is split into processing chunks. The processing chunks are portions of the processing job (i.e., sub-jobs, sub-tasks, etc.) that may be handled by different processing nodes so that the processing job may be handled in parallel and thus more quickly. In some examples, the processing job may not be split into chunks if the characteristics of the job do not call for it. For example, if the processing job is extremely small or low priority, it may be kept whole and distributed to a single processing node.

The method 300 then proceeds to step 312 where the processing chunks are distributed to on-site nodes (e.g., node 132 of FIG. 1) and the cloud processing node (e.g., node 142 of FIG. 1). In some examples, workload orchestration module 114 and cloud burst orchestration module 118 of FIG. 1 coordinate the distribution of the processing chunks. Further, in some examples, AI module 120 of FIG. 1 may work in concert with workload orchestration module 114 and cloud burst orchestration module 118 in order to distribute the processing chunks according to a predicted maximum efficiency allocation.

The processing chunks may be distributed to different nodes in a distributed computing resource system based on many different factors. For example, a node may be chosen for a processing chunk based on characteristics of the nodes, such as the number or type of processors in the node, or the applications installed at the nodes (e.g., as discussed with respect to FIG. 2), etc. Using the example above of a video transcoding job, it may be preferable to distribute the processing chunks to nodes that include special purpose processors, such as powerful GPUs, which can processing the processing chunks very efficiently. A node may also be chosen based on current resource utilizations at the node. For example, if a node is currently heavily utilized by normal activity (such as a personal workstation) or by other processing tasks associated with the distributed computing resource system, it may not be selected for distribution of the processing chunk. A node may also be chosen based on scheduled availability of the node. For example, a node that is not scheduled for system availability for several hours may not be chosen while a node that is scheduled for system availability may be preferred. In some cases, where for example the percentage of available processing utilization available at a node is based on schedules, the system may calculate the relative availability of nodes taking into account the schedule constraints. A node may also be chosen based on network conditions at the node. For example, if a mobile processing node (e.g., a laptop computer) is connected via a relatively lower speed connection (e.g., a cellular connection), it may not be preferred where another node with a faster connection is available. Notably, these are just a few examples of the type of logic that may be used for distributing the processing chunks to nodes in the distributed computing resource system.

In the present example, one or more of the processing chunks may be distributed to the cloud processing node to overcome any resource shortage in the on-site computing resources. Thus, using the example above, one or more individual chunks of a video file to be transcoded may be distributed to the cloud processing nodes in an effort to get the best performance for the processing job.

The method 300 then proceeds to step 314 where the status of the processing chunks is monitored at the various nodes. For example, workload orchestration module 114 of FIG. 1 may receive monitoring information from the various nodes as they process the chunks.

In some cases, during step 314 an on-site node may go offline or experience some other sort of performance problem, such as loss of resource availability. In such cases, a chunk may be reassigned to the cloud processing node in order to maintain the overall progress of the processing job.

The method 300 then proceeds to step 316 where processed chunks are received from the on-site nodes as well as the cloud processing node. For example, workload orchestration module 114 of FIG. 1 may receive the processed chunks.

Though not depicted in FIG. 3, a management system (e.g., management system 100 of FIG. 1) may record performance statistics of each completed processing job. The performance statistics may be used, for example, by an AI (e.g., AI module 120 of FIG. 1) to affect the way a workload orchestration module (e.g., workload orchestration module 114 of FIG. 1) allocates processing jobs or the way in which cloud burst orchestration module 118 (of FIG. 1) manages the routing of processing to cloud resources.

The method 300 then proceeds to step 318 where the processed chunks are reassembled into a completed processing job and provided to a requestor. Using the example above, the transcoded chunks of the video file may be reassembled into a single, transcoded video file ready for consumption.

In the event any chunks of the original video file were distributed to more than one node for processing, those nodes may be instructed to cease any unfinished processing (e.g., via workload orchestration module 114 of FIG. 1) and to delete the in-progress data.

Notably, the steps of method 300 described above are just some examples. In other embodiments, some of the steps may be omitted, additional steps may be added, or the order of the steps may be altered. Method 300 is described for illustrative purposes and is not indicative of the total range of capabilities of, for example, management system 100 of FIG. 1.

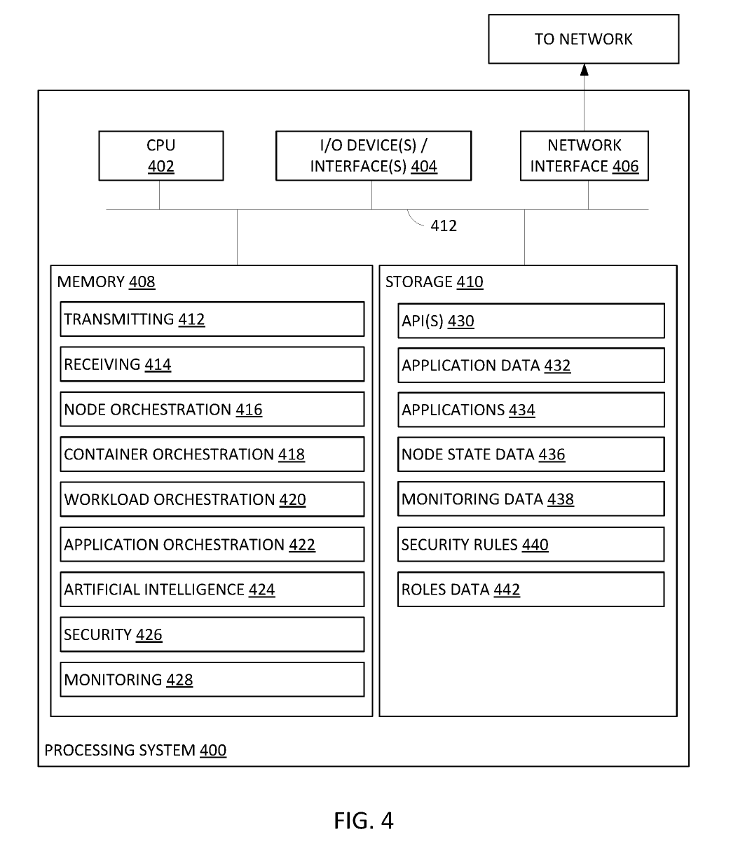

FIG. 4 depicts a processing system 400 that may be used to perform methods described herein, such as the method 300 for demand-based utilization of cloud computing resources described above with respect to FIG. 3.

Processing system 400 includes a CPU 402 connected to a data bus 412. CPU 402 is configured to process computer-executable instructions, e.g., stored in memory 408 or storage 410, and to cause processing system 400 to perform methods as described herein, for example with respect to FIG. 3. CPU 402 is included to be representative of a single CPU, multiple CPUs, a single CPU having multiple processing cores, and other forms of processing architecture capable of executing computer-executable instructions. In some implementations, CPU may be another form of processor, such as a graphics processing unit (GPU), special purpose processing unit (SPPU), or the like.

Processing system 400 further includes input/output device(s) and interface(s) 404, which allows processing system 400 to interface with input/output devices, such as, for example, keyboards, displays, mouse devices, pen input, and other devices that allow for interaction with processing system 400. Note that while not depicted with independent external 110 devices, processing system 400 may connect with external 110 devices through physical and wireless connections (e.g., an external display device).

Processing system 400 further includes network interface 406, which provides processing system 400 with access to external networks and thereby external computing devices.

Processing system 400 further includes memory 408, which in this example includes transmitting component 412 and receiving component 414, which may perform transmitting and receiving functions as described above with respect to FIGS. 1-3.

Memory 408 further includes node orchestration component 416, which may perform node orchestrations functions as described above with respect to FIGS. 1-3.

Memory 408 further includes container orchestration component 418, which may perform container orchestrations functions as described above with respect to FIGS. 1-3.

Memory 408 further includes workload orchestration component 420, which may perform workload orchestrations functions as described above with respect to FIGS. 1-3.

Memory 408 further includes node application component 422, which may perform application orchestrations functions as described above with respect to FIGS. 1-3.

Memory 408 further includes node artificial intelligence (AI) 424, which may perform AI functions as described above with respect to FIGS. 1-3.

Memory 408 further includes security component 426, which may perform security functions as described above with respect to FIGS. 1-3.

Memory 408 further monitoring component 428, which may perform monitoring functions as described above with respect to FIGS. 1-3.

Note that while shown as a single memory 408 in FIG. 4 for simplicity, the various aspects stored in memory 408 may be stored in different physical memories, but all accessible CPU 402 via internal data connections, such as bus 412, or external data connections, such as network interface 406 or 110 device interfaces 404.

Processing system 400 further includes storage 410, which in this example includes application programming interface (API) data 430, such as described above with respect to FIGS. 1-3.

Storage 410 further includes application data 432, such as described above with respect to FIGS. 1-3.

Storage 410 further includes applications 434 (e.g., installation files, binaries, libraries, etc.), such as described above with respect to FIGS. 1-3.

Storage 410 further includes node state data 436, such as described above with respect to FIGS. 1-3.

Storage 410 further includes monitoring data 438, such as described above with respect to FIGS. 1-3.

Storage 410 further includes security rules 440, such as described above with respect to FIGS. 1-3.

Storage 410 further includes roles data 442, such as described above with respect to FIGS. 1-3.

While not depicted in FIG. 4, other aspects may be included in storage 410.

As with memory 408, a single storage 410 is depicted in FIG. 4 for simplicity, but the various aspects stored in storage 410 may be stored in different physical storages, but all accessible to CPU 402 via internal data connections, such as bus 412, I/O interfaces 404, or external connection, such as network interface 406.

### EXAMPLE EMBODIMENTS

Embodiment 1: A method for managing distributed computing resources, comprising: receiving a processing job request comprising parameters associated with a processing job; determining that available system resources are insufficient to process the processing job; installing a container in a cloud processing node; installing an application in the container in the cloud processing node; splitting a processing job into a plurality of chunks; and distributing at least one of the plurality of chunks to an on-site processing node and at least another one of the plurality of chunks to a cloud processing node.

Embodiment 2: The method of Embodiment 1, wherein determining that available system resources are insufficient to process the processing job comprises determining a total resource utilization of the system is above a predetermined threshold.

Embodiment 3: The method of any of Embodiments 1-2, wherein determining that available system resources are insufficient to process the processing job comprises determining that the available system resources are insufficient to complete the processing job in a time interval.

Embodiment 4: The method of any of Embodiments 1-3, further comprising: monitoring a processing status of the chunk at the on-site processing node and the chunk at the cloud processing node.

Embodiment 5: The method of Embodiment 4, further comprising: determining a processing performance issue at the on-site processing node; and reassigning the chunk assigned to the on-site processing node to the cloud processing node.

Embodiment 6: The method of any of Embodiment 1-5, further comprising: receiving completed chunks from the on-site processing node and the cloud processing node.

Embodiment 7: The method of Embodiment 6, further comprising: providing the completed chunks to a requestor via an interface.

Embodiment 8: A non-transitory computer-readable medium comprising instructions for performing a method for managing distributed computing resources, the method comprising: receiving a processing job request comprising parameters associated with a processing job; determining that available system resources are insufficient to process the processing job; installing a container in a cloud processing node; installing an application in the container in the cloud processing node; splitting the processing job into a plurality of chunks; and distributing at least one of the plurality of chunks to an on-site processing node and at least another one of the plurality of chunks to a cloud processing node.

Embodiment 9: The non-transitory computer-readable medium of Embodiment 8, wherein determining that available system resources are insufficient to process the processing job comprises determining a total resource utilization of the system is above a predetermined threshold.

Embodiment 10: The non-transitory computer-readable medium of any of Embodiments 8-9, wherein determining that available system resources are insufficient to process the processing job comprises determining that the available system resources are insufficient to complete the processing job in a time interval.

Embodiment 11: The non-transitory computer-readable medium of any of Embodiments 8-10, the method further comprising: monitoring a processing status of the chunk at the on-site processing node and the chunk at the cloud processing node.

Embodiment 12: The non-transitory computer-readable medium of Embodiment 11, the method further comprising: determining a processing performance issue at the on-site processing node; and reassigning the chunk assigned to the on-site processing node to the cloud processing node.

Embodiment 13: The non-transitory computer-readable medium of any of Embodiments 8-12, the method further comprising: receiving completed chunks from the on-site processing node and the cloud processing node.

Embodiment 14: The non-transitory computer-readable medium of Embodiment 13, the method further comprising: providing the completed chunks to a requestor via an interface.

Embodiment 15: An apparatus for managing distributed computing resources, comprising: a memory comprising computer-executable instructions; a processor in data communication with the memory and configured to execute the computer-executable instructions and cause the apparatus to: receive a processing job request comprising parameters associated with a processing job; determine that available system resources are insufficient to process the processing job; install a container in a cloud processing node; install an application in the container in the cloud processing node; split the processing job into a plurality of chunks; and distribute at least one of the plurality of chunks to an on-site processing node and at least another one of the plurality of chunks to a cloud processing node.

Embodiment 16: The apparatus of Embodiment 15, wherein in order to determine that available system resources are insufficient to process the processing job, the processor is further configured to cause the apparatus to: determine a total resource utilization of the system is above a predetermined threshold.

Embodiment 17: The apparatus of any of Embodiments 15-16, wherein in order to determine that available system resources are insufficient to process the processing job, the processor is further configured to cause the apparatus to: determine that the available system resources are insufficient to complete the processing job in a time interval.

Embodiment 18: The apparatus of any of Embodiments 15-17, wherein the processor is further configured to cause the apparatus to: monitor a processing status of the chunk at the on-site processing node and the chunk at the cloud processing node.

Embodiment 19: The apparatus of Embodiment 18, wherein the processor is further configured to cause the apparatus to: determine a processing performance issue at the on-site processing node; and reassign the chunk assigned to the on-site processing node to the cloud processing node.

Embodiment 20: The apparatus of any of Embodiments 15-19, wherein the processor is further configured to cause the apparatus to: receive completed chunks from the on-site processing node and the cloud processing node.

Embodiment 21: The apparatus of any of Embodiments 15-19, wherein the processor is further configured to cause the apparatus to: provide the completed chunks to a requestor via an interface.

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for managing distributed computing resources, comprising:
receiving a processing job request comprising parameters associated with a processing job;
determining that available system resources are insufficient to process the processing job;
installing a container in a cloud processing node;
installing an application in the container in the cloud processing node;
splitting the processing job into a plurality of chunks; and
distributing at least one of the plurality of chunks to an on-site processing node and at least another one of the plurality of chunks to a cloud processing node.

2. The method of claim 1, wherein determining that available system resources are insufficient to process the processing job comprises determining a total resource utilization of the system is above a predetermined threshold.

3. The method of claim 1, wherein determining that available system resources are insufficient to process the processing job comprises determining that the available system resources are insufficient to complete the processing job in a time interval.

4. The method of claim 1, further comprising: monitoring a processing status of the chunk at the on-site processing node and the chunk at the cloud processing node.

5. The method of claim 4, further comprising:
determining a processing performance issue at the on-site processing node; and
reassigning the chunk assigned to the on-site processing node to the cloud processing node.

6. The method of claim 1, further comprising: receiving completed chunks from the on-site processing node and the cloud processing node.

7. The method of claim 6, further comprising: providing the completed chunks to a requestor via an interface.

8. A non-transitory computer-readable medium comprising instructions for performing a method for managing distributed computing resources, the method comprising:
receiving a processing job request comprising parameters associated with a processing job;
determining that available system resources are insufficient to process the processing job;
installing a container in a cloud processing node;
installing an application in the container in the cloud processing node;
splitting the processing job into a plurality of chunks; and
distributing at least one of the plurality of chunks to an on-site processing node and at least another one of the plurality of chunks to a cloud processing node.

9. The non-transitory computer-readable medium of claim 8, wherein determining that available system resources are insufficient to process the processing job comprises determining a total resource utilization of the system is above a predetermined threshold.

10. The non-transitory computer-readable medium of claim 8, wherein determining that available system resources are insufficient to process the processing job comprises determining that the available system resources are insufficient to complete the processing job in a time interval.

11. The non-transitory computer-readable medium of claim 8, the method further comprising: monitoring a processing status of the chunk at the on-site processing node and the chunk at the cloud processing node.

12. The non-transitory computer-readable medium of claim 11, the method further comprising:
determining a processing performance issue at the on-site processing node; and
reassigning the chunk assigned to the on-site processing node to the cloud processing node.

13. The non-transitory computer-readable medium of claim 8, the method further comprising: receiving completed chunks from the on-site processing node and the cloud processing node.

14. The non-transitory computer-readable medium of claim 13, the method further comprising: providing the completed chunks to a requestor via an interface.

15. An apparatus for managing distributed computing resources, comprising:
a memory comprising computer-executable instructions;
a processor in data communication with the memory and configured to execute the computer-executable instructions and cause the apparatus to:
receive a processing job request comprising parameters associated with a processing job;
determine that available system resources are insufficient to process the processing job;
install a container in a cloud processing node;
install an application in the container in the cloud processing node;
split the processing job into a plurality of chunks; and
distribute at least one of the plurality of chunks to an on-site processing node and at least another one of the plurality of chunks to a cloud processing node.

16. The apparatus of claim 15, wherein in order to determine that available system resources are insufficient to process the processing job, the processor is further configured to cause the apparatus to: determine a total resource utilization of the system is above a predetermined threshold.

17. The apparatus of claim 15, wherein in order to determine that available system resources are insufficient to process the processing job, the processor is further configured to cause the apparatus to: determine that the available system resources are insufficient to complete the processing job in a time interval.

18. The apparatus of claim 15, wherein the processor is further configured to cause the apparatus to: monitor a processing status of the chunk at the on-site processing node and the chunk at the cloud processing node.

19. The apparatus of claim 18, wherein the processor is further configured to cause the apparatus to:
determine a processing performance issue at the on-site processing node; and
reassign the chunk assigned to the on-site processing node to the cloud processing node.

20. The apparatus of claim 15, wherein the processor is further configured to cause the apparatus to: receive completed chunks from the on-site processing node and the cloud processing node.

21. The apparatus of claim 15, wherein the processor is further configured to cause the apparatus to: provide the completed chunks to a requestor via an interface.
